(19) United States
(12) Patent Application Publication
(10) Pub. No.: US 2004/0177037 A1
(43) Pub. Date: Sep. 9, 2004

(54) System and method for credit card service linked with credit loan service whose bounds are limited with the amount of selling

(76) Inventor: Min-su Lee, Sungnam-si (KR)

Correspondence Address: STANZIONE & KIM, LLP, 1740 N STREET, N.W., FIRST FLOOR, WASHINGTON, DC, 20036, US

(21) Appl. No.: 10/484,390

(22) PCT Filed: Jul. 24, 2002
(86) PCT No.: PCT/KR02/01395

(30) Foreign Application Priority Data
Jul. 27, 2001 (KR) 2001-0045463

(51) Int. Cl. G06F 17/60

(52) U.S. Cl. 705/39; 705/38

(57) ABSTRACT

The present invention relates to a credit card service system that relates the amount of purchase to a credit limit, and a method thereof. The credit card service method according to the present invention includes the first step of collecting information on purchases made under the authorization between a credit card inquiry machine and a server of a value added network (VAN) company, the second step of combining the collected information on purchases into a total and then notifying the total to a bank server with which the merchant has a card account, and the third step of automatically applying a credit limit to the card account of the merchant in proportion of the notified total. According to the present invention, the merchant does not have to wait for a credit card issuer to transfer the payment for the purchases made on customers credit card. In other words, immediately after the purchase, the merchant can use a certain amount of fund according to the purchase made on the customers credit card. If the merchant does not use the fund, the merchant is no liable to an interest. For the banks part, as the bank can allow cash advance on security of sales receipt, which is authorized by the credit card issuer, the bank has the advantages of safe investment and secured profit.

### FIELD OF THE INVENTION

The present invention relates to a credit card service system and a method thereof, and more particularly to a method for enabling a merchant accepting credit cards to use the necessary amount money out of the sales generated through credit card transaction before formal payment from a credit card company is made, by means of immediately applying the corresponding merchant's credit limit according to the sales the merchant made through credit card transaction.

### DESCRIPTION OF THE RELATED ART

Referring to FIG. 1, a conventional process of credit card payment will be outlined below:

If a customer wishes to make a credit card payment on the purchases made at a merchant accepting credit cards, the merchant requests for the authorization of the credit card payment to a VAN (Value Added Network) company.

The VAN company then passes the request to a corresponding credit card company and after receiving a reply regarding the request, sends the reply to the merchant originally requested the authorization.

When the credit card payment is authorized, selling is completed as the merchant provides a customer the customer's copy of a receipt. The authorized sales produced through credit card transaction is paid into the bank with which the corresponding merchant has an account by the credit card company after a certain period of time, and the merchant withdraws and uses cash from its account.

However, such conventional credit card service system has the following problems:

1. Although the credit card transaction is successfully authorized, immediate encashment of the sales is not possible as it takes a certain period of time for the merchant to receive the authorized settlement into its account from the credit card company.

2. Accordingly, settlement on credit enabling prompt payment for the merchant's authorized transaction was introduced. Nevertheless, in the merchant's position, it is disadvantageous because unnecessary fees incur due to immediate encashment of unnecessary amount.

3. Since payments from the credit card company are settled into the merchant's account at different times depending on the credit card company, management of the receipts becomes complicated and it takes a lot of time and efforts to balance account with respect to the sales generated through the credit card transaction.

4. If there is a communication problem between a merchant and a VAN company, the merchant cannot generate sales since transactions using credit cards become impossible and disputes can arise between the merchant, a customer and the VAN company as the customer without cash cannot make a payment.

That is, since a conventional credit card inquiry machine can be connected only to a single VAN company, when there is a communication problem between the merchant and the VAN company or between the VAN company and the credit card company, no credit card payment can be made.

### DISCLOSURE OF THE INVENTION

An object of the present invention developed to solve the above problems is to enable a merchant accepting credit cards to use the necessary amount of money out of the sales generated through credit cards transaction even before the sales are credited from a credit card company, by means of immediately applying the corresponding merchant's credit limit according to the sales the merchant made through credit card transaction.

Another object of the present invention is to significantly improve the success rate of the credit card transaction by multiplying a VAN server that can be connected to the credit card inquiry machine.

In order to achieve another objects, the credit card service system with sales and a credit loan limit linked according to the present invention comprises a credit card inquiry machine located at each merchant accepting credit cards, a VAN server performing a role for authorizing a credit card by connecting to credit card inquiry machines in a certain area, a credit card company server managing transaction using credit cards by connecting to the VAN server, and a bank server connected to the credit card company server and managing settlement account of the merchant accepting credit cards, the improvement further comprises an intermediate server collecting sales information on a credit card from the credit card inquiry machines and/or the VAN server, and transmitting the collected sales information to the bank server of a bank with which the merchant accepting credit cards has an account, wherein the bank server increases the credit loan limit determined in the account of the merchant which generates corresponding sales in proportional to the sales information received from the intermediate server.

The credit card inquiry machines connect to plurality of VAN servers and try credit card inquiry by automatically connecting with other VAN server in case credit card inquiry is not successful between the credit card inquiry machine and a currently connected VAN server and the credit card inquiry machines are structured for a user to be able to manually select a particular VAN server among the plurality of VAN servers for a VAN server to try connection.

The intermediate server further comprises a function of summing up and providing the sales information of the merchant accepting credit cards generated by each VAN company in accordance with the merchant's request and the role of the intermediate server is performed by the VAN server or directly by the bank server.

In order to achieve another objects, the credit card service method with sales and a credit loan limit linked according to the present invention comprises a first step of collecting sales information of authorized transaction from a credit card company through more than one VAN server performing a role for authorizing a credit card by connecting with a credit card inquiry machine located in each merchant accepting credit card and/or a credit card inquiry machine in a certain area, a second step of summing up the sales information collected in the first step by each merchant accepting credit cards and reporting the same to a server of a bank with which the corresponding merchant has a bank account, and a third step in which the bank server that receives the sales information in the second step automatically applies a certain credit loan limit proportional to sales to the corresponding bank account of the merchant accepting credit cards.

In the second step, the sales information collected from the credit card inquiry machine is verified using the sales information collected from the corresponding VAN server, and then only the verified sales information is summed up as sales information of the corresponding merchant accepting credit cards when sales information of the merchant accepting credit cards is collected by both the credit card inquiry machine in the merchant and the VAN server at the first step. The credit loan is a loan by a minus account charging interests only on used amount out of predetermined limit.

According to the present invention, the merchant does not have to wait for the payment made on the credit card to be settled by the credit card company. That is, the merchant can immediately use the money made by sales on a credit card and does not have to pay for unnecessary interest when there is no need of the immediate use of the money.

In addition, the bank with which the merchant has its account can safely manage the bank fund by allowing a credit loan based on safe receivables authorized by the credit card company, and generate interest income with respect to the amount of money the merchant pre-used.

In particular, if the transaction path is multiplied by connecting the credit card inquiry machine with the plurality of VAN company, transaction can successfully be made as an alternative VAN company can be used when there is an access problem with a particular VAN company. Therefore, disputes with clients due to transaction trouble can be significantly reduced.

Such effect of reducing disputes can be produced in between the credit card inquiry machine and any VAN company. In addition, the VAN company can improve the satisfaction rate of the merchant, which is a client of its own and accordingly the credit card company can improve the sales by increasing the success rate of the transaction using credit cards.

### DESCRIPTION OF THE DRAWINGS

FIG. 1 is a schematic view showing a conventional credit card payment process;

FIG. 2 is a structural view showing an embodiment of a service system according to the present invention;

FIG. 3 is a flow chart showing an embodiment of a service method according to the present invention;

FIG. 4 is a schematic view showing implementation of the service of the present invention using the system of the FIG. 3.

FIG. 5 is an example of a system structure for multiplying transaction path;

FIG. 6 is an embodiment about a transaction authorization request process when the transaction path is multiplied; and

FIG. 7 is a flow chart showing an embodiment of a sales information summing up process.

### BEST MODE OF THE INVENTION

The following detailed description will present a preferred embodiment of the present invention in reference to the accompanying drawings.

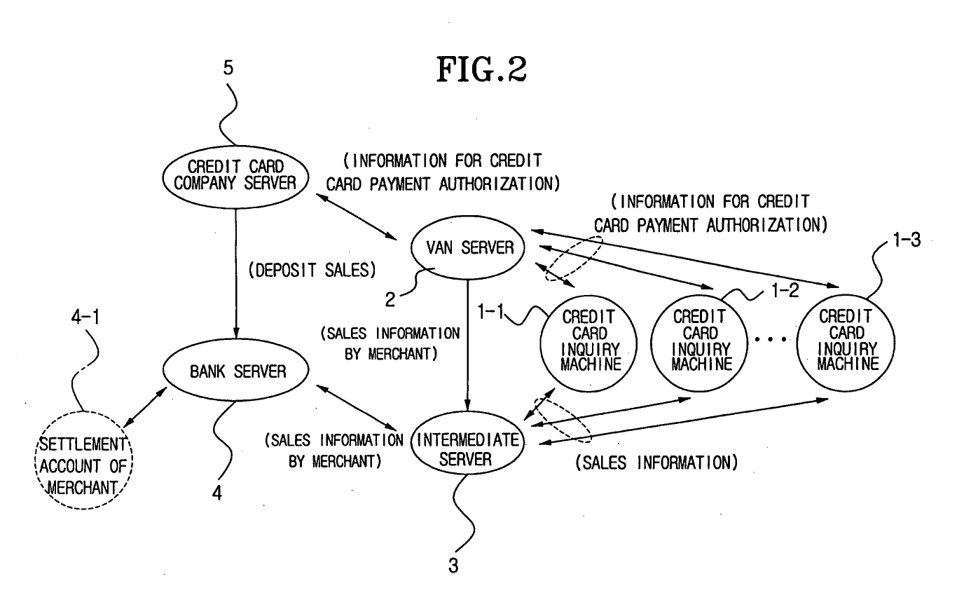

Referring to FIG. 2, the credit card service system according to the present invention has a credit card inquiry machine 1-1, 1-2, 1-3 located at each merchant accepting credit cards, a VAN server 2 performing a role for authorizing credit card transaction by connecting to credit card inquiry machines in a certain area, a server of a credit card company 5 managing credit card transaction by connecting to more than one VAN server, and a server of a bank 4 with which a merchant has an account and into which the corresponding sales of a merchant is received from the credit card company server 5 are interconnected through a predetermined network.

To describe in detail, the credit card inquiry machine 1-1, 1-2, 1-3 transmits information (for example, transaction number, card number, MS information, expiry date, number of months for installment, price of goods, fees, tax, merchant information and transaction time) requested by the credit card company and receives information (for example, transaction trace number, process time, authorization number and code of grounds) from the credit card company in reply.

The VAN company is an agent mainly performing a rote of authorizing credit card transaction and a credit card inquiry machine 1-1, 1-2, 1-3 is generally installed by a single VAN company among the plurality of VAN companies. The credit card inquiry machine 1-1, 1-2, 1-3 and the VAN server 2 can connect to each other through a communication line such as a Public Switched Telephone Network (PSTN), a wireless communication network, a private line, or CO-LAN.

Meanwhile, the credit card service system according to the present invention further comprises an intermediate server 3 as shown in FIG. 2. The intermediate server 3 is structured to connect to the credit card inquiry machine 1-1, 1-2, 1-3 located in each merchant or the VAN server 2, and has a function of collecting information on sales generated through credit cards via the credit card inquiry machine 1-1, 1-2, 1-3 or the VAN server 2 and then providing the collected sales information to the server of a bank 4 with which the corresponding merchant has an account. The intermediate server 3 and the bank server 4 can be connected though internet, a separate private cable, or a wireless transceiving system. Since such connecting methods are well-know matter, the detailed description of them will be omitted. Additionally, it is possible that either the bank server 4 is enabled to function as an intermediate server 3 by integrally forming the intermediate server 3 with the bank server 4, or the VAN server 3 is enabled to function as an intermediate server 3 by integrally forming the intermediate server 3 with the VAN server 2.

The bank server 4 automatically and immediately applies the credit limit proportional to the sales information received form the intermediate server 3 to the account 4-1 of a merchant which has corresponding sales generated. Therefore, such service can be distinguished from other services unconditionally crediting money such as credit settlement or vicarious settlement, and the considerable amount of costs can be reduced.

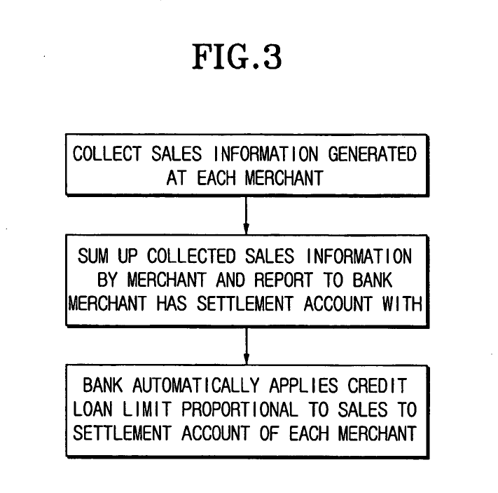

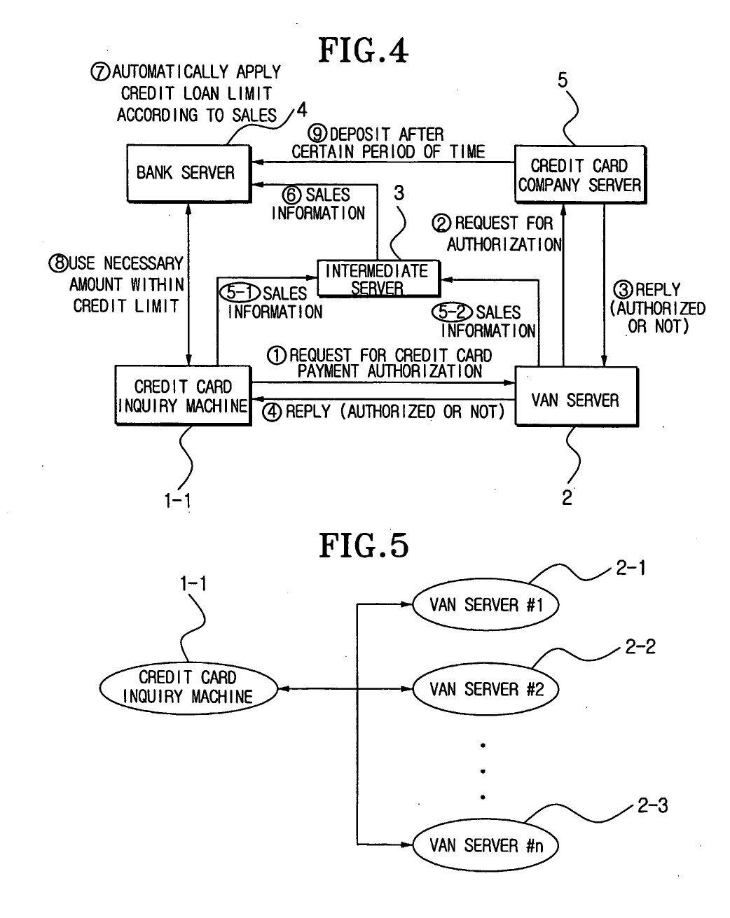

Referring to FIGS. 3 and 4, a detailed description of the implementation process of the service according to the present invention will be presented.

First of all, the intermediate server 3 collects the authorized credit card sales information generated from a credit card inquiry machine 1-1, 1-2, 1-3 located at each merchant. The sales information of each merchant may be received either from the credit card inquiry machine 1-1, 1-2, 1-3 or each VAN server 2, and may also from both the credit card inquiry machine 1-1, 1-2, 1-3 and each VAN server 2 at need. (S10: Step 1)

Referring to FIG. 4, more detailed description of the first step (S10) will be provided.

When a customer using a merchant tries to make a payment on a credit card for the goods and services purchased, the merchant transmits a telegram requesting authorization of the credit card payment to a VAN server 2 using a credit card inquiry machine 1-1.

Then the VAN server 2 transmits the authorization request received from the credit card inquiry machine 1-1 to a credit card company server 5. After a response with respect to the authorization request is received from the credit card company server 5, the VAN server 2 transmits the response to the corresponding credit card inquiry machine 1-1.

Accordingly, the credit card inquiry machine 1-1 and the VAN server 2 become able to know the authorization details and the credit card inquiry machine 1-1 and the VAN server 2 transmit the authorized sales information of the merchant to the intermediate server 3 thereby letting the intermediate server 3 collect sales information by each merchant.

The intermediate server 3 sums up the collected sales information at the first step (S10) by each credit card merchant and reports the result to the server of the bank 4 with which the merchant has an account. (S20: Step 2)

Then the bank server 4 which received the sales information at the second step automatically applies a certain credit loan limit proportional to the sales to the merchant's bank account. (S30: Step 3) That is, the bank server 4 has a database containing data with respect to the bank account in the name of the corresponding merchant, the merchant owner, or a person designated by the merchant, and the database includes the credit loan limit of each bank account. Therefore, when the information of the merchant having sales generated and the data of the generated sales are received, the bank server 4 can apply the credit loan limit corresponding to the sales to the bank account by increasing the data of the credit loan limit established in the corresponding merchant's account as much as or by a certain amount proportional to the sales.

It is preferable that the credit loan charges interests only on the amount currently being used out of the predetermined limit. That way the merchant can immediately use the necessary amount of money and reduce unnecessary costs as no interest is charged on the unused amount.

The credit loan limit increases every time the authorized transaction is generated, and reduces as the transaction is deliberately canceled in such case that the goods are returned after the selling is made. In addition, credit with respect to credit card receivables can be flexibly granted as the credit loan limit is immediately reduced when the credit card company settles the payment for the corresponding authorized transaction and cash is credited into the corresponding settlement account.

Meanwhile, in the above described first step (S10), if an authorization inquiry is not processed successfully due to a problem in the VAN server 2 while the credit card inquiry machine 1-1 and the VAN server 2, or the VAN server 2 and the credit card server 5 are communicating, the VAN server 2 transmits a telegram reporting such circumstances to the credit card inquiry machine 1-1.

In that case, the merchant should receive payments in other methods such as cash since the credit card cannot be used. If a reply telegram is not received at all, that means some kind of problem occurred in the credit card transaction process and transaction using the credit card inquiry machine cannot be successfully processed until the problem is solved.

Therefore, as shown in FIG. 5, it is preferable that each credit card inquiry machine 1-1 is structured to connect to the plurality of VAN servers 2-1 through 2-3 and to automatically connect to other VAN server for a credit card inquiry when a credit card inquiry is not successfully processed while being connected to the current VAN server.

When it is said that a credit card inquiry is not processed successfully, it means there is a problem between a credit card inquiry machine and a VAN server such as a transaction failure due to a communication problem, a time out in which a connection is made but a reply telegram is not received, or when a reply telegram is received but the reply indicates a refusal code meaning that the transaction cannot be successfully made due to various kinds of problems. Therefore, cases in which the credit card itself has a problem such as limit excess, stolen card, invalidated expiry date cannot be included.

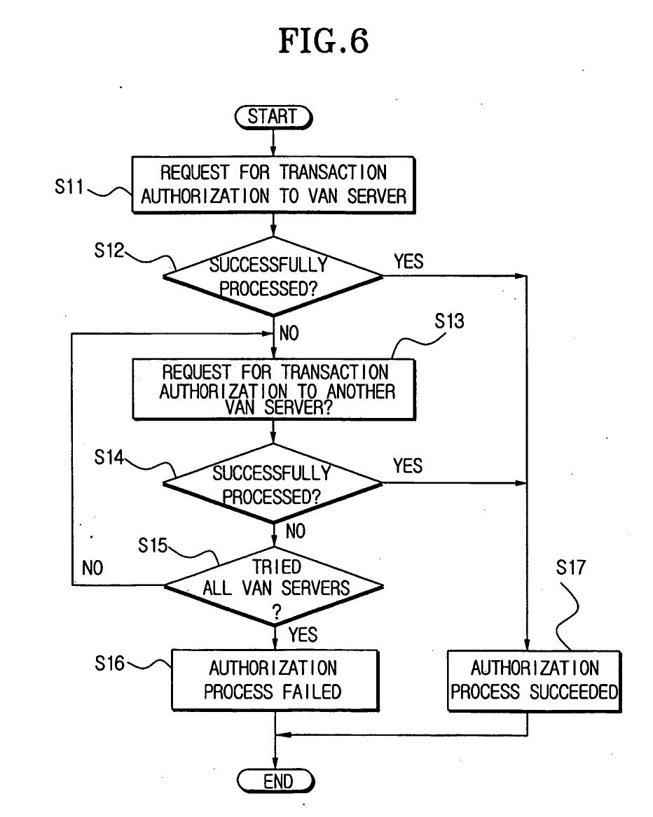

Referring to FIG. 6 a process of multiplying a transaction path will be described in detail.

The credit card inquiry machine 1-1 requests for authorization of the credit card transaction by connecting to a particular VAN server 1-1 out of several VAN servers 2-1 through 2-3 which are available for connection. (S11) If the request is successfully processed at the step S11 receiving an authorization or refusal reply (S12), the authorization process for the corresponding credit card is successfully completed. (S17) On the other hand, if the request is not successfully processed at the step S11, the credit card inquiry machine automatically connects to the next VAN server 2-2 and requests for authorization for credit card transaction. (S13) If the request is successfully processed at the step S11 receiving an authorization or refusal reply (S14), the authorization process for corresponding credit card is successfully completed. (S17) In case the request is not successfully processed at the step S13 (S14), if still there is a VAN server left for trying (S15), the credit card inquiry machine moves back to the step S13 and requests for the authorization of the credit card transaction by connecting to that VAN server but if not, the authorization process for the corresponding credit card ends in failure. (S16).

However, the success rate of transaction can be remarkably improved since it is extremely rare that many VAN servers have a problem at the same time. That is, since the merchant can immediately reattempt transaction via other VAN company despite the transaction problem occurred with a particular VAN company, sales decrease caused by a problem with a VAN company can be prevented and disputes with customers due to delay or transaction failure do not occur.

While it is preferable that the credit card machines 1-1, 1-2, 1-3 are automatically connected to other VAN server in case of a transaction failure, it is more preferable that the credit card inquiry machines 1-1, 1-2, 1-3 are structured for a user to be able to manually select a particular VAN server from the plurality of VAN servers 2-1, 2-2, 2-3 as a particular VAN server may be preferred for transaction depending on the merchant's circumstances. In that case, a means for a manual selection such as a hot key should be provided in the credit card inquiry machine.

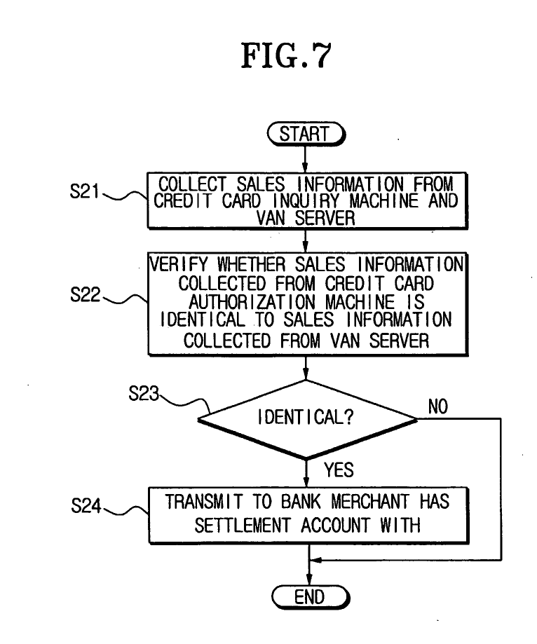

Referring to FIG. 7, another embodiment with respect to a sales information collecting process performed at the second step (S20) will be described hereinafter.

More accurate summing up may be realized by the following process: When sales information of each credit card merchant is collected in the first step (S10) from both the credit card inquiry machine and the VAN server (S21), the intermediate server 3 verifies whether the sales information collected from the credit card inquiry machine and the sales information collected from the corresponding VAN server are identical. (S22) After the verification process, the intermediate server 4 sums up only the verified identical sales information as the sales information of the corresponding merchant, and transmits that information to the corresponding bank server 4. (S23, S24)

The transaction results of a merchant are collected and summed up by a particular VAN server which provided a credit card inquiry machine. If a transaction path is multiplied as mentioned above, it is preferable that summing up or account balancing is performed after transaction and settlement results of each VAN server are collected together. However, since the intermediate server 3 according to the present invention receives the current sales state of a merchant from each VAN server, sales related information of each VAN server can be collected together and summed up. That is, it is more preferable that the intermediate server 3 has an additional function of collecting the sales state of the corresponding merchant occurred between the corresponding merchant and the VAN server together according to the request from each merchant and performs summing up or settlement of the account.

In each embodiment described above, the role of intermediate server 3 for collecting and summing up sales information generated in each merchant and reporting to the corresponding bank server can be performed either by a separate server installed by a third party or each VAN server.

In addition, such role of the intermediate server 3 can be performed directly by a bank server and in this case, the bank server collects sales information of the corresponding merchant from credit card inquiry machines of merchants who have a bank account in the same bank or each VAN server connecting to those credit card inquiry machines and sums up the collected information.

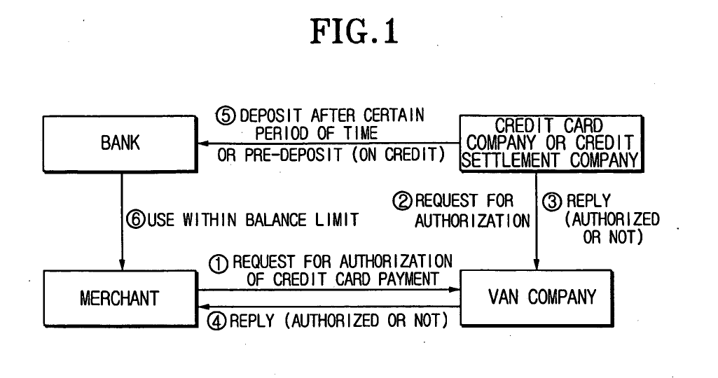

Although the present invention was limited to a credit card in the above description, it can also be applied to any transaction system, for example, a credit card, a debit card, a prepaid card, and an IC card settlement system, which has the same structure and process as the example shown in FIG. 1. Moreover, the present invention can be applied to the settlement system of a distributor, a discount store and a large restaurant connected to a VAN company through a POS or server of its own for flexible credit loan service. That is, such system can be operated in the same way by additionally providing an intermediate server performing a role described above and adding a function of setting up a credit loan limit proportional to the sales to a bank server 4.

What is claimed is:

1. A credit card service system with sales and a credit loan limit linked comprising: a credit card inquiry machine located at each merchant accepting credit cards; a VAN server performing a role for authorizing a credit card by connecting to credit card inquiry machines in a certain area; a credit card company server managing transaction using credit cards by connecting to the VAN server; and a bank server connected to the credit card company server and managing settlement account of the merchant accepting credit cards, the improvement further comprises an intermediate server collecting sales information on a credit card from the credit card inquiry machines and/or the VAN server, and transmitting the collected sales information to the bank server of a bank with which the merchant accepting credit cards has an account,
wherein the bank server increases the credit loan limit determined in the account of the merchant which generates corresponding sales in proportional to the sales information received from the intermediate server.

2. The credit card service system with sales and a credit loan limit linked according to claim 1, wherein the credit card inquiry machines connect to plurality of VAN servers and try credit card inquiry by automatically connecting to other VAN server in case credit card inquiry is not successful between the credit card inquiry machine and a currently connected VAN server.

3. The credit card service system with sales and a credit loan limit linked according to claim 2, wherein the credit card inquiry machines are structured for a user to be able to manually select a particular VAN server among the plurality of VAN servers for a VAN server to try connection.

4. The credit card service system with sales and a credit loan limit linked according to either claim 2 or claim 3, wherein the intermediate server further comprises a function of summing up and providing the sales information of the merchant accepting credit cards generated by each VAN company in accordance with a request of the merchant.

5. The credit card service system with sales and a credit loan limit linked according to claim 1, wherein the role of the intermediate server is performed by the VAN server.

6. The credit card service system with sales and a credit loan limit linked according to claim 1, wherein the role of the intermediate server is directly performed by the bank server.

7. A credit card service method with sales and a credit loan limit linked comprising:
a first step of collecting sales information of authorized transaction from a credit card company through at least one VAN server performing a role for authorizing a credit card by connecting with a credit card inquiry machine located in each merchant accepting credit card and/or a credit card inquiry machine in a certain area;
a second step of summing up the sales information collected in the first step by each merchant accepting credit cards and reporting the same to a server of a bank with which the corresponding merchant has a bank account; and
a third step in which the bank server that receives the sales information in the second step automatically applies a certain credit loan limit proportional to sales to the corresponding bank account of the merchant accepting credit cards.

8. The credit card service method with sales and a credit loan limit linked according to claim 7, wherein, in the second step, the sales information collected from the credit card inquiry machine is verified using the sales information collected from the corresponding VAN server and then only the verified sales information is summed up as sales information of the corresponding merchant accepting credit cards when sales information of the merchant accepting credit cards is collected by both the credit card inquiry machine in the merchant and the Van server at the first step.

9. The credit card service method with sales and a credit loan limit linked according to either claim 7 or claim 8, wherein the credit loan is a loan by a minus account charging interests only on used amount out of predetermined limit.
